(19) United States
(12) Patent Application Publication
(10) Pub. No.: US 2018/0214898 A1
(43) Pub. Date: Aug. 2, 2018

(54) DEVICE FOR CONTAINING AND SUPPLYING LIQUIDS

(71) Applicants: Bruno MEI, Poggio Mirteto (IT); Walter MEI, Poggio Mirteto (IT); Erika MEI, Poggio Mirteto (IT)

(72) Inventors: Bruno MEI, Poggio Mirteto (IT); Walter MEI, Poggio Mirteto (IT); Erika MEI, Poggio Mirteto (IT)

(21) Appl. No.: 15/745,525

(22) PCT Filed: Jul. 15, 2016
(86) PCT No.: PCT/IT2016/000175

§ 371 Date: Jan. 17, 2018

(30) Foreign Application Priority Data
Jul. 22, 2015 (IT) 102015000036900

(51) Int. Cl. B05B 11/00

(52) U.S. Cl. CPC B05B 11/3015; B05B 11/0086

(57) ABSTRACT

The present invention relates to a device for containing and supplying liquids, comprising a containing unit (100) provided with a main compartment (3A) for containing liquids, a supplying unit (200) comprising a supplying conduct (4) arranged between a first opening for activating supply and a second opening for supplying liquids, pumping means (6), to permit pumping of liquids from said supplying conduct (4) outward said device (1) for containing and supplying liquids, said pumping means (6) being provided in correspondence of said first activating opening, first anti-extraction means (5) for preventing said pumping means (6) from being extracted from said supplying conduct (4), an exit valve (12) provided in said supplying conduct (4), said exit valve (12) being movable between an opening position, in which exit of liquids from said supplying conduct (4) is permitted through said second liquid supplying opening, and a closure position, in which exit of liquids from said supplying conduct (4) through said second liquid supplying opening is prevented, said exit valve (12) being further realized in such a way to place in said opening position when said pumping means (6) are activated, second anti-extraction means (15) to prevent extraction of said exit valve (12), at least one aeration valve (9) to let air entering into said supplying conduct (4) during the pumping action due to said pumping means (6), at least one passage (8) between said main compartment (3a) and said supplying conduct (4), to permit the passage of liquid from said main compartment (3a) toward said supplying conduct (4); wherein at least a hole (3b′) is realized in said supplying unit to let air passing from outside of said containment and supplying device (1) inside said supplying conduct (4), through said at least an aeration valve (9), and wherein said containment unit (100), said supplying conduct (4), said first anti-extraction means (5) and said second anti-extraction means (15) are realized in a single piece so that their separation is possible only breaking the same.

The present invention relates to a device for containing and supplying liquids.

Particularly, said device for containing and supplying liquids is so configured to make it evident every tampering attempt aimed at unauthorized filling in of the same liquid.

Although in the following specification it is made reference to a bottle, the present invention must not be intended as limited to this particular kind of container.

To this end, it is further noted that the bottle described in the following can be conveniently employed to contain very precious food liquids, such easy, e.g., wine, oil, vinegar and liquors.

Different members and supplying apparatuses are known to be applied to the mouth of the bottles to make supplying easier of the liquid contained therein.

However, said known members and apparatuses have different disadvantages and drawbacks, mainly due to the fact that they have such a structure and operation permitting unauthorized filling of bottles.

In view of the above, it is therefore an object of the present invention that of providing a device for containing and supplying liquids, making every tampering attempt, aimed at filling in the same container, well evident.

It is therefore a specific object of the present invention a device for containing and supplying liquids, comprising a containing unit provided with a main compartment for containing liquids, a supplying unit provided with a supplying conduct arranged between a first opening for activating supply and a second opening for supplying liquids, pumping means, to permit pumping of liquids from said supplying conduct outward said device for containing and supplying liquids, said pumping means being provided in correspondence of said first activating opening, first anti-extraction means for preventing said pumping means from being extracted from said supplying conduct, an exit valve provided in said supplying conduct, said exit valve being movable between an opening position, in which exit of liquids from said supplying conduct is permitted through said second liquid supplying opening, and a closure position, in which exit of liquids from said supplying conduct through said second liquid supplying opening is prevented, said exit valve being further realized in such a way to place in said opening position when said pumping means are activated, second anti-extraction means to prevent extraction of said exit valve, at least one aeration valve to let air entering into said supplying conduct during the pumping action due to said pumping means, at least one passage between said main compartment and said supplying conduct, to permit the passage of liquid from said main compartment toward said supplying conduct; wherein at least a hole is realized in said supplying unit to let air passing from outside of said containment and supplying device inside said supplying conduct, through said at least an aeration valve, and wherein said containment unit, said supplying conduct, said first anti-extraction means and said second anti-extraction means are realized in a single piece so that their separation is possible only breaking the same.

Further, according to the invention, said at least one aeration valve can be connected to said supplying conduct, downward said at least one passage.

Advantageously, according to the invention, said one exit valve may comprise a compression spring, a shutter on which said compression spring rests and a guide element, along which said shutter slides.

Preferably, according to the invention, a seat is obtained in said guide element, wherein said compression spring is housed.

Still according to the invention, said guide element can be integral with said second anti-extraction means.

Furthermore, according to the invention, said second anti-extraction means can comprise a grid, provided in said supplying conduct and integral with said supplying conduct.

Preferably, according to the invention, said grid is provided downward said exit valve.

Advantageously, according to the invention, said first anti-extraction means comprise a narrowing formed in said supplying conduct (4) and said pumping means may comprise a piston, comprising a first enlarged end portion, a second enlarged end portion and a narrow intermediate portion between said first enlarged end portion and second enlarged end portion; said narrow intermediate portion being arranged such as to cross said narrowing; said pumping means further comprising elastic means arranged in said supplying conduct so as to interact with said piston.

Preferably, according to the invention, said elastic means comprise a compression spring, placed adjacent with respect to said narrowing.

Further, according to the invention, said supplying conduct can comprise a first conduct segment, where said pumping means are provided, said at least one aeration valve being connected with the first conduct segment, and a second conduct segment substantially orthogonally arranged with respect to said first conduct segment, said exit valve being provided in said second conduct segment.

Preferably, according to the invention, said containment and supplying device has a substantially bottle-shape.

Still according to the invention, said supplying unit can be provided in correspondence of said bottle bottom.

Advantageously, according to the invention, said second liquid supplying opening can be realized on the bottom of the bottle.

Further, according to the invention, said pumping means can be actuated by a lateral wall of said bottle.

Still according to the invention, said liquid containment and supplying device can have a security device which can be placed on the mouth of said bottle to prevent from non-authorized removal of a cap provided on said mouth.

The present invention will be now described for illustrative, but not limitative purposes according to is preferred embodiment, with particular reference to the figures of the enclosed drawings, wherein:

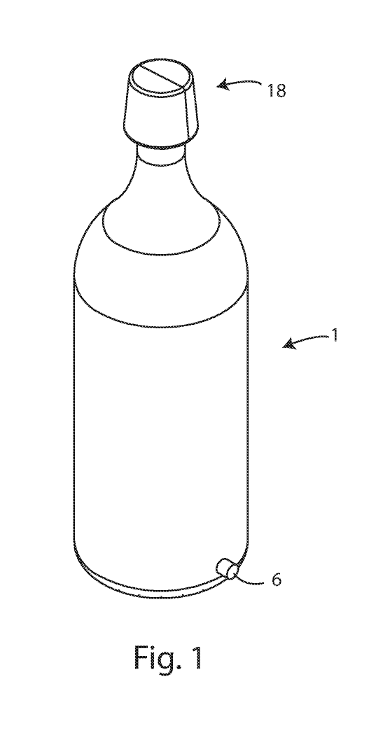

FIG. 1 is a perspective view of a liquid supplying bottle;

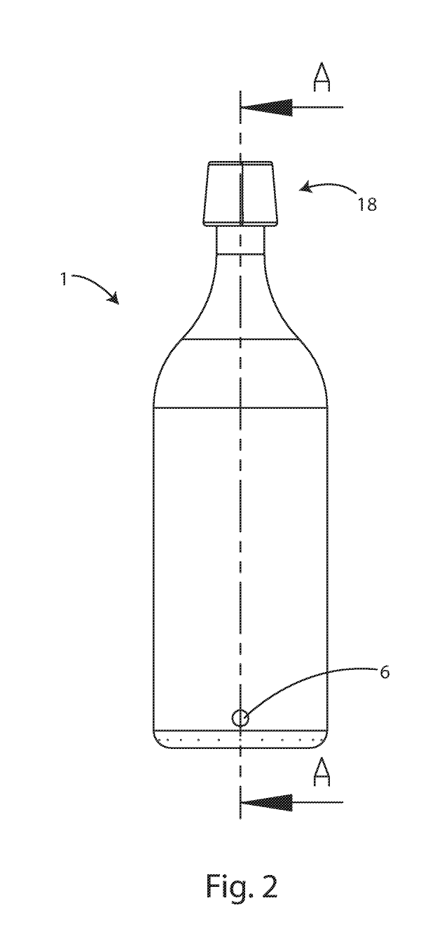

FIG. 2 is a lateral view of the bottle shown in FIG. 1;

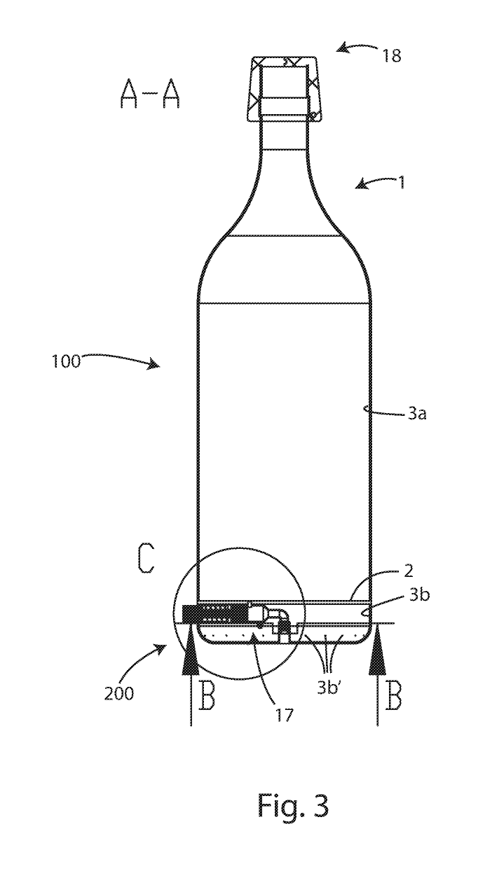

FIG. 3 is a section view taken along the section line A-A indicated in FIG. 2;

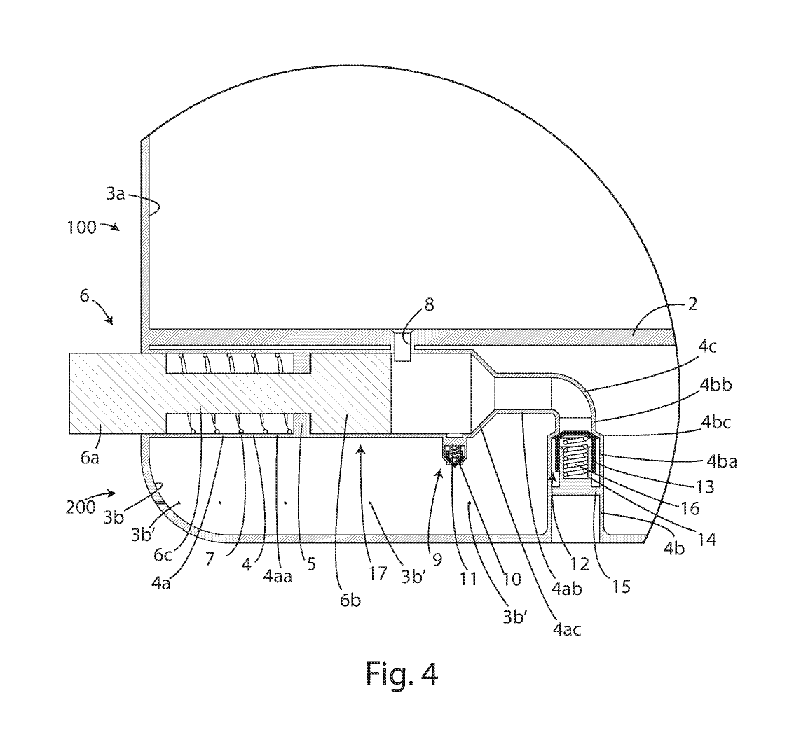

FIG. 4 is an enlarged view of detail C shown in FIG. 3;

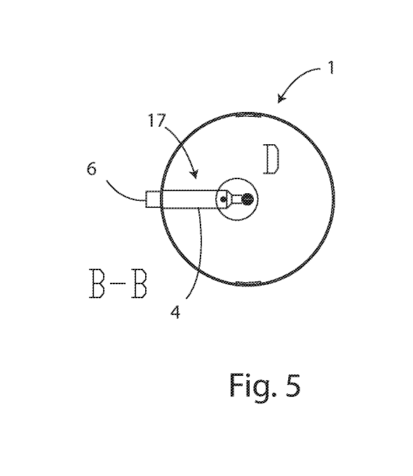

FIG. 5 is a section view taken along the section line B-B shown in FIG. 3;

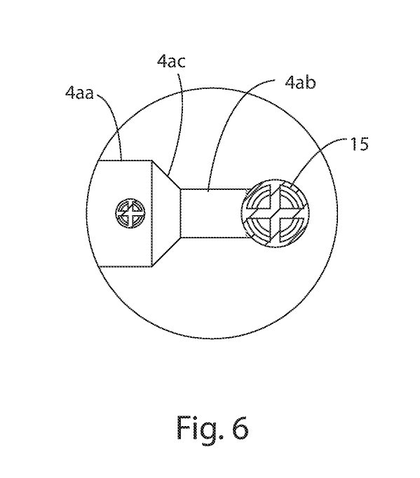

FIG. 6 is an enlarged view of detail D shown in FIG. 5; and

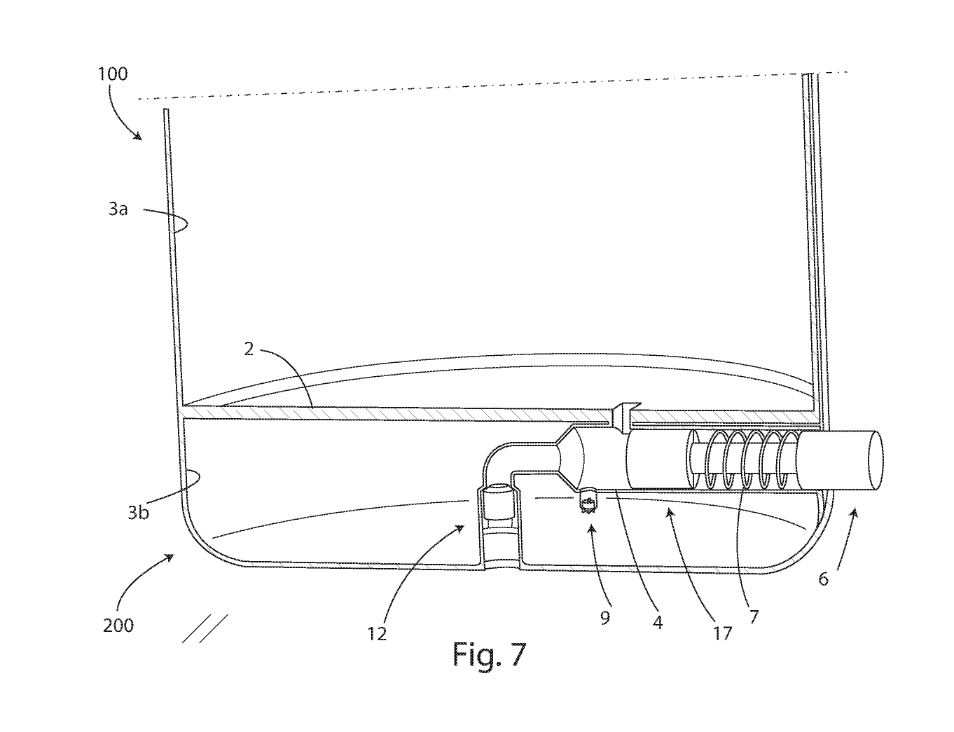

FIG. 7 is a partial exploded view of the bottle shown in FIG. 1.

In the various figures, similar parts will be indicated with the same reference numerals.

Referring to the enclosed figures, with reference number 1 is shown a bottle for the containment of oil, wine, vinegar, liquor or other liquids.

The bottle 1 is internally divided, by a partition wall 2, in a main compartment 3a for containing the liquid, provided on its upper part, and a secondary compartment 3b, smaller than said main compartment 3a and arranged in correspondence of the bottom of the bottle 1.

The bottle 1 is thus formed by an upper containment unit 100, in which it is internally defined the main compartment 3a, and a lower dispensing unit 200, in which the secondary compartment 3b is defined.

In the delivery unit 200 it is realized a plurality of holes 3b′, circumferentially arranged, for the entry of air from outside into the secondary compartment 3b.

In the secondary compartment 3b, a delivery channel 4 is realized by a first radial portion 4a, which opens on the side wall of the bottle 1, a second longitudinal portion 4b, ending on the bottom of the bottle 1, and a connecting element 4c—made by a 90° bend—connecting each other said first radial portion 4a and the second longitudinal portion 4b.

Particularly, the first radial portion 4a is in its turn formed by an enlarged section portion 4aa, ending in the side wall of the bottle 1, a narrow section portion 4ab, directly connected to the connecting element 4c, and a narrowing portion 4ac having a frusto-conical shape.

Similarly, also the second longitudinal portion 4b of the supplying channel 4 is formed by a section enlarged portion 4ba, opening into the bottom of the bottle 1, a narrow section portion 4bb, directly connected to the connecting element 4c, and a connection portion 4cb having a frusto-conical shape.

In the radial first portion 4a of the supplying channel 4, a narrowing 5 is formed and a piston 6 is arranged, consisting of a first outer enlarged portion 6a, protruding from the lateral wall of the bottle 1, a second inner enlarged portion 6b and a central portion 6c passing through said narrowing 5.

Otherwise, both the first outer enlarged portion 6a and the second inner enlarged portion 6b have such dimensions not be able to cross the narrowing 5 present in the dispensing channel 4.

In the supplying channel 4 it is also present a first compression spring 7 abutted between the narrowing 5 and the first outer enlarged portion 6a of the piston 6.

Said piston 6 is thus movable between a rest position, in which the second inner enlarged portion 6b of the piston 6 is in abutment with the narrowing 5, and a maximum thrust position in said second internal enlarged portion 6b contacts said narrowing portion 4ac.

A through hole 8 is formed In the partition wall 2, so as to put in fluid communication the above mentioned primary compartment 3a of the bottle 1 and the enlarged section portion 4aa of the first portion 4a of the radial delivery channel 4.

Particularly, the through hole 8 is opened in a part of the enlarged section portion 4aa between the narrowing portion 4ac and the piston 6 when in its rest position (see FIG. 4).

Said through hole 8 is therefore provided in a position so as to allow the passage of fluid from the main compartment 3a to the supplying channel 4 when the piston 6 is in the rest position, and to prevent said passage when the piston 6 is in the maximum thrust position, since it is clogged by the same second inner enlarged portion 6b of the latter.

A first valve 9 is connected to that part of the enlarged section portion 4aa in which the through hole 8 is provided to let air entering, communicating with the secondary compartment 3b.

Specifically, said first valve 9 is provided with a first shutter 10 on which a second compression spring 11 acts so that when the second compression spring 11 is in the rest position, the first valve 9 is closed (see FIG. 4), preventing the passage of air through the same, and so that when the second compression spring 11 is compressed, the first valve 9 is open, allowing the passage of air through the same.

Particularly, the first valve 9 is placed in such a position to be, with respect to the through hole 8, closer to the narrowing portion 4ac.

In the second longitudinal portion 4b of the supplying channel 4 it is present a second supplying valve 12 realized by a second shutter 13 able to slide on a support guide 14 extending upward with respect to a transverse grid 15 provided in the enlarged section portion 4ba of said second longitudinal section 4b.

The support guide 14 also has an internal cavity in which a third compression spring 16 is housed, directly insisting on the second shutter 13, so that when the third compression spring 16 is in the rest position it pushes the second shutter 13 in abutment against said connecting portion 4cb, determining the closing of the second valve 12, and so that when instead the third compression spring 16 is compressed, said second valve 12 is open, so as to allow the passage of liquid through the same and therefore the relative leakage from the bottom of the bottle 1.

Based on the above, the set of components described in the foregoing, provided in the secondary compartment 3b, constitutes a kind of supplying device 17 to supply the liquid from the bottle 1 present in its main compartment 3a.

A security device 18 can be also applied onto the mouth of the bottle 1 to prevent the unauthorized removal of the cap of the same bottle 1.

With respect to the embodiment of the invention shown in the enclosed figures and described in the above, it should be noted that the containment unit 100 and the supplying unit 200 of the bottle 1 are realized as a single piece.

According to the operation of the bottle 1, when the piston 6 is in the rest position (see FIG. 4) the first shutter 10 and the second shutter 13 are both in the closed position, and the liquid present in the main compartment 3a can flow across the through hole 8 in the part of the supplying channel 4 between the piston 6 and said second shutter 13.

When the piston 6 is pressed from outside to the maximum thrust position, the first valve 9 is closed and the liquid present in the above-mentioned part of the supplying channel 4 is pushed by said piston 6 against said second shutter 13, causing it to lower and determining thereby the opening of the second valve 12, and then the leakage of a given quantity of liquid from the bottom of the bottle 1 through the above-mentioned transverse grid 15.

When instead the piston 6 from the position of maximum thrust goes back to the rest position, the second valve 12 is closed, while in the part of the supplying channel 4 between the piston 6 and said second shutter 13 progressively create a depression condition that will cause the opening of the first valve 9 and the consequent passage of air from the secondary compartment 3b to the supplying channel 4, which will allow the liquid, once the second internal enlarged portion 6b of the piston 6 will have freed the through hole 8, to flow again from the primary compartment to the third supplying channel 4.

The bottle 1 described above is then configured so as to be capable of delivering predetermined amounts of liquid, while making evident any tampering attempt aimed at unauthorized filling of the same bottle 1.

Any tampering of the bottle 1 made in correspondence of the access routes to the main compartment 3a where it is contained the liquid would be, in any case, obvious from the outside.

In fact, an unauthorized removal of the security device 18 provided on the mouth of the bottle 1 would only be possible following a breakage or a noticeable deformation of the same security device 18.

Similarly, also the removal of the piston 6 or of the shutter of said second valve 12, to access the through hole 8, and then to the main compartment 3a, would only be possible following the rupture of the portion of the delivery channel 4 realizing the above narrowing 5, in the first case, and the transverse grid 15 in the second case.

In the same way, also in case one wishes extracting the second shutter 13 of the supplying unit 200 to abusively refill the containment unit 100 through the exit for the liquid to be supplied, this operation may only be carried out after breaking of the transverse grid 15, thereby making it evident the attempt of unauthorized filling.

Furthermore, also a possible attempt to drive the supplying separation unit 200 from the containment unit 100 for filling of the latter, would produce the desired effect only in consequence of a breakdown, since, as mentioned above, the unit containment 100 and the supplying unit 200 are realized integrally, i.e. as a single piece.

The present invention has been described for illustrative but not limitative purposes, according to its preferred embodiments, but it is to be understood that variations and/or modifications may be introduced by those skilled in the art without departing from the scope, as defined by the enclosed claims.

1. A device (1) for containing and supplying liquids, comprising:
a containing unit (100) provided with a main compartment (3A) for containing liquids,
a supplying unit (200) comprising:
a supplying conduct (4) arranged between a first opening for activating supply and a second opening for supplying liquids,
pumping means (6), to permit pumping of liquids from said supplying conduct (4) outward said device (1) for containing and supplying liquids, said pumping means (6) being provided in correspondence of said first activating opening,
first anti-extraction means (5) for preventing said pumping means (6) from being extracted from said supplying conduct (4),
an exit valve (12) provided in said supplying conduct (4), said exit valve (12) being movable between an opening position, in which exit of liquids from said supplying conduct (4) is permitted through said second liquid supplying opening, and a closure position, in which exit of liquids from said supplying conduct (4) through said second liquid supplying opening is prevented, said exit valve (12) being further realized in such a way to place in said opening position when said pumping means (6) are activated,
second anti-extraction means (15) to prevent extraction of said exit valve (12),
at least one aeration valve (9) to let air entering into said supplying conduct (4) during the pumping action due to said pumping means (6),
at least one passage (8) between said main compartment (3a) and said supplying conduct (4), to permit the passage of liquid from said main compartment (3a) toward said supplying conduct (4);
wherein at least a hole (3b′) is realized in said supplying unit to let air passing from outside of said containment and supplying device (1) inside said supplying conduct (4), through said at least an aeration valve (9), and
wherein said containment unit (100), said supplying conduct (4), said first anti-extraction means (5) and said second anti-extraction means (15) are realized in a single piece so that their separation is possible only breaking the same.

2. The device (1) for containing and supplying liquids according to claim 1, wherein said at least one aeration valve (9) is connected to said supplying channel (4) downward said at least one passage (8).

3. The device (1) for containing and supplying liquids according to claim 1, wherein said one exit valve (12) comprises a compression spring (16), a shutter (13) on which said compression spring (16) rests and a guide element (14), along which said shutter (13) slides.

4. The device (1) for containing and supplying liquids according to claim 3, wherein a seat is obtained in said guide element (14), wherein said compression spring (16) is housed.

5. The device (1) for containing and supplying liquids according to claim 3, wherein said guide element (14) is integral with said second anti-extraction means (15).

6. The device (1) for containing and supplying liquids according to claim 1, wherein said second anti-extraction means comprise a grid (15), provided in said supplying conduct (4) and integral with said supplying conduct (4).

7. The device (1) for containing and supplying liquids according to claim 6, wherein said grid (15) is provided downward said exit valve (12).

8. The device (1) for containing and supplying liquids according to claim 1, wherein said first anti-extraction means comprise a narrowing (5) formed in said supplying conduct (4) and said pumping means comprise a piston (6), comprising a first enlarged end portion (6a), a second enlarged end portion (6b) and a narrow intermediate portion (6c) between said first enlarged end portion (6a) and second enlarged end portion (6b); said narrow intermediate portion (6c) being arranged such as to cross said narrowing (5); said pumping means further comprising elastic means (7) arranged in said supplying conduct (4) so as to interact with said piston (6).

9. The device (1) for containing and supplying liquids according to claim 8, wherein said elastic means comprise a compression spring (7), placed adjacent with respect to said narrowing (5).

10. The device (1) for containing and supplying liquids according to claim 1, wherein said supplying conduct (4) comprises a first conduct segment, where said pumping means (6) are provided, said at least one aeration valve (9) being connected with the first conduct segment (4b), and a second conduct segment (4b) substantially orthogonally arranged with respect to said first conduct segment (4a), said exit valve (12) being provided in said second conduct segment (4b).

11. The device (1) for containing and supplying liquids according to claim 1, wherein said containment and supplying device (1) has a substantially bottle-shape.

12. The device (1) for containing and supplying liquids according to claim 1, wherein said supplying unit (200) is provided in correspondence of a bottom of said device (1).

13. The device (1) for containing and supplying liquids according to claim 1, wherein said second liquid supplying opening is realized on a bottom of the device (1).

14. The device (1) for containing and supplying liquids according to claim 1, wherein said pumping means (6) are actuated by a lateral wall of said device (1).

15. The device (1) for containing and supplying liquids according to claim 1, wherein said liquid containment and supplying device (1) has a security device (18) which can be placed on the mouth of said device (1) to prevent from non-authorized removal of a cap provided on said mouth.
